(19) United States
(12) Patent Application Publication
(10) Pub. No.: US 2020/0162642 A1
(43) Pub. Date: May 21, 2020

(54) IMAGING ABNORMALITY DIAGNOSIS DEVICE AND VEHICLE

(71) Applicant: Toyota Jidosha Kabushiki Kaisha, Toyota-shi (JP)

(72) Inventor: Wataru Oniki, Tokyo-to (JP)

(21) Appl. No.: 16/682,385

(22) Filed: Nov. 13, 2019

(30) Foreign Application Priority Data
Nov. 15, 2018 (JP) 2018-215041

(51) Int. Cl. H04N 5/217; G06K 9/00; B60R 11/04

(52) U.S. Cl. CPC H04N 5/2171; G06T 2207/30261; B60R 11/04; G06K 9/00805

(57) ABSTRACT

An imaging abnormality diagnosis device is configured to: acquire an image of surroundings of a vehicle captured by a vehicle-mounted camera; acquire 3D information of surroundings of the vehicle detected by a 3D sensor; identify a region of the image in which an object should appear based on the acquired 3D information t; analyze the image to thereby detect an imaging degree as a degree by which an object is captured in a predetermined region of the image; and judge that an abnormality has occurred in imaging by the vehicle-mounted camera when the imaging degree in the region, in which the object should appear, is equal to or less than a predetermined degree.

### CROSS-REFERENCE TO RELATED APPLICATION

The present application claims priority under 35 U.S.C. § 119 to Japanese Patent Application No. 2018-215041, filed on Nov. 15, 2018. The contents of this application is incorporated herein by reference in its entirety.

### FIELD

The present disclosure relates to an imaging abnormality diagnosis device and a vehicle including an imaging abnormality diagnosis device.

### BACKGROUND

In recent years, numerous vehicles have been equipped with vehicle-mounted cameras for capturing the surroundings of the vehicles. Such vehicle-mounted cameras are, for example, used for monitoring the situation surrounding the vehicle and warning the drivers when sensing danger or for enabling a vehicle to be partially or completely autonomously driven.

In a vehicle-mounted camera capturing the surroundings of a vehicle, sometimes drops of water, snow, mud, dust, and other foreign matter will deposit on a lens or a protective member (for example, windshield, etc.) provided in front of the lens. If such foreign matter deposits, the foreign matter will appear in the captured image and it will no longer be possible to suitably warn the driver or enable the vehicle to be autonomously driven.

Therefore, a device for detecting deposition of such foreign matter on a lens, etc., of a vehicle-mounted camera has been proposed (for example, PTL 1). In particular, the device described in PTL 1 calculates, for each region of an image captured by a vehicle-mounted camera, the intensity of a high frequency component of the image in that region, and judges the presence of any foreign matter on the lens of the vehicle-mounted camera based on the calculated intensity.

### CITATIONS LIST

### Patent Literature

[PTL 1] Japanese Unexamined Patent Publication No. 2015-026987

### SUMMARY

### Technical Problem

In this regard, in the device described in PTL 1, when the intensity of the high frequency component of a region is low, it is judged that foreign matter has deposited at a position of the lens corresponding to that region and that an abnormality has occurred in the lens, etc. However, the image captured by a vehicle-mounted camera sometimes, for example, includes large walls of a building, etc. In a region where such a wall is represented, the high frequency component is lower in intensity. In this case, abnormality of the lens, etc., is erroneously judged.

In view of such a problem, an object of the present disclosure is to keep erroneous judgment from occurring when diagnosing abnormality of a lens, etc., of a vehicle-mounted camera.

### Solution to Problem

Embodiments of the present disclosure solve the above problem and has as its gist the following.

(1) An imaging abnormality diagnosis device, comprising: an image acquiring part acquiring an image of surroundings of a vehicle captured by a vehicle-mounted camera; a 3D information acquiring part acquiring 3D information of surroundings of a vehicle detected by a 3D sensor; a region identifying part identifying a region of the image in which an object should appear based on the 3D information acquired by the 3D information acquiring part; an imaging degree detecting part analyzing the image to thereby detect an imaging degree as a degree by which an object is captured in a predetermined region of the image; and a diagnosing part judging that an abnormality has occurred in imaging by the vehicle-mounted camera when the imaging degree in the region, in which the object should appear, is equal to or less than a predetermined degree.

(2) The imaging abnormality diagnosis device according to above (1), wherein a texture degree of the image is used as the imaging degree, and the higher the texture degree of the image, the higher the imaging degree to the image is treated as.

(3) The imaging abnormality diagnosis device according to above (1), wherein a confidence level of an object being present in each region in an image is used as the imaging degree, and the higher the confidence level, the higher the imaging degree to the image is treated as.

(4) The imaging abnormality diagnosis device according to any one of above (1) to (3), wherein the imaging degree detecting part detects the imaging degree in only a region in which the object should appear.

(5) The imaging abnormality diagnosis device according to any one of above (1) to (4), wherein the diagnosing part judges that an abnormality has occurred in imaging by the vehicle-mounted camera, when a statistical value obtained by time series processing of an imaging degree in a region detected by the imaging degree detecting part for a plurality of images in which the region identified by the region identifying part is the same as each other, is equal to or less than a predetermined value.

(6) A vehicle comprising an imaging abnormality diagnosis device according to any one of above (1) to (5), further comprising: a vehicle-mounted camera capturing the surroundings of the vehicle; and a 3D sensor detecting 3D information of the surroundings of the vehicle, the vehicle-mounted camera and the 3D sensor being attached at different portions of the vehicle.

### Advantageous Effects

According to the present disclosure, erroneous judgment when diagnosing an abnormality in a lens of a vehicle-mounted camera etc. is suppressed.

### BRIEF DESCRIPTION OF DRAWINGS

FIG. 1 is a view schematically showing the constitution of a vehicle in which an imaging abnormality diagnosis device according to an embodiment is mounted.

FIG. 2 is a view of a hardware configuration of an ECU.

FIG. 3 is a functional block diagram of an ECU relating to imaging abnormality detection processing.

FIG. 4 is a view schematically showing a relationship of 3D coordinates of a 3D sensor and a vehicle-mounted camera, and image coordinates.

FIG. 5 shows one example of an image captured by a vehicle-mounted camera and acquired by an image acquiring part.

FIG. 6 shows another example of an image captured by a vehicle-mounted camera and acquired by an image acquiring part.

FIG. 7 is a flow chart showing imaging abnormality diagnosis processing according to a first embodiment.

FIG. 8 is a flow chart, similar to FIG. 7, showing imaging abnormality diagnosis processing according to a second embodiment.

### DESCRIPTION OF EMBODIMENTS

Below, referring to the drawings, an imaging abnormality diagnosis device and a vehicle including an imaging abnormality diagnosis device, according to an embodiment, will be explained in detail. Note that, in the following explanation, similar component elements are assigned the same reference notations.

### First Embodiment

<<Configuration of Vehicle>>

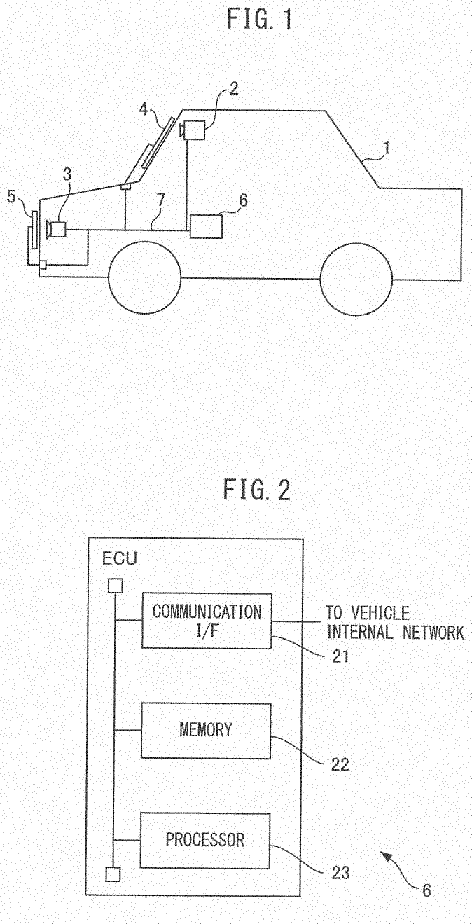

FIG. 1 is a view schematically showing the configuration of a vehicle in which an imaging abnormality diagnosis device according to the present embodiment is mounted. As shown in FIG. 1, the vehicle 1 includes a vehicle-mounted camera 2, 3D sensor 3, first wiper 4 and second wiper 5, and electronic control unit (ECU) 6. The vehicle-mounted camera 2, 31) sensor 3, first wiper 4, second wiper 5, and ECU 6 are connected so as to be able to communicate with each other through a vehicle internal network 7 based on the CAN (Controller Area Network) or other standards.

The vehicle-mounted camera 2 captures a predetermined range around the vehicle and generates an image of that range. The vehicle-mounted camera 2 includes a lens and imaging element and is, for example, a CMOS (complementary metal oxide semiconductor) camera or CCD (charge coupled device) camera.

In the present embodiment, the vehicle-mounted camera 2 is provided at the vehicle 1 and captures the surroundings of the vehicle 1. Specifically, the vehicle-mounted camera 2 is provided at the inside of a front window of the vehicle 1 and captures the region in front of the vehicle 1. For example, the vehicle-mounted camera 2 is provided at the top center of the front window of the vehicle 1. The vehicle-mounted camera 2 captures the region in front of the vehicle 1 and generates an image of the front region, at every predetermined imaging interval (for example 1/30 sec to 1/10 sec) while the ignition switch of the vehicle 1 is on. The image generated by the vehicle-mounted camera 2 is sent from the vehicle-mounted camera 2 through the vehicle internal network 7 to the ECU 6. The image generated by the vehicle-mounted camera 2 may be a color image or may be a gray image.

The 3D sensor 3 detects 3D information in a predetermined range around the vehicle. The 3D sensor 3, for example, measures the distances from the 3D sensor 3 to objects present in different directions therefrom to detect 3D information of the surroundings of the vehicle. The 3D information is, for example, point cloud data showing objects present in the different directions around the vehicle 1. The 3D sensor 3 is, for example, a LiDAR (light detection and ranging) or milliwave radar.

In the present embodiment, the 3D sensor 3 is provided at the vehicle 1 and detects 3D information of the surroundings of the vehicle 1. Specifically, the 3D sensor 3 is provided near the front end part of the vehicle 1 and detects 3D information at the region in front of the vehicle 1. For example, the 3D sensor 3 is provided in a bumper. The 3D sensor 3 scans the region in front at predetermined intervals while the ignition switch of the vehicle 1 is on, and measures the distances to objects in the surroundings of the vehicle 1. The 3D information generated by the 3D sensor 3 is sent from the 3D sensor 3 through the vehicle internal network 7 to the ECU 6.

Note that, the vehicle-mounted camera 2 and 3D sensor 3 may also be provided at positions different from the back surface of the room mirror or inside of the bumper, so long as being attached to portions of the vehicle 1 different from each other. Specifically, for example, the vehicle-mounted camera 2 and 3D sensor 3 may be provided on the ceiling of the vehicle 1 or may be provided in a front grille of the vehicle 1. In particular, if both the vehicle-mounted camera 2 and 3D sensor 3 are provided at the same part (for example, front window), the vehicle-mounted camera 2 and the 3D sensor 3 are attached to different portions of the same part, and for example, the vehicle-mounted camera 2 is attached to the center top while the 3D sensor 3 is attached to the center side.

Further, the vehicle-mounted camera 2 may be provided so as to capture the region in back of the vehicle 1. Similarly, the 3D sensor 3 may also be provided to detect 3D information at the region in back of the vehicle 1.

The first wiper 4 is disposed at the front of the front window so as to wipe the front window of the vehicle 1. The first wiper 4 is driven so as to swing back and forth over the front of the front window. If driven, the first wiper 4 can wipe off any foreign matter on the front window in the front of the vehicle-mounted camera 2. The second wiper 5 is disposed at the bumper so as to wipe the portion of the bumper in the surroundings of the 3D sensor 3 (part formed by material passing laser beam of 3D sensor). The second wiper 5 is driven so as to swing back and forth over the front of the bumper. If driven, the second wiper 5 can wipe off any foreign matter on the portion of the bumper in the front of the 3D sensor 3. The first wiper 4 and second wiper 5 are both sent drive signals from the ECU 6 through the vehicle internal network 7.

The ECU 6 functions as an imaging abnormality diagnosis device diagnosing an abnormality in imaging by the vehicle-mounted camera 2. In addition, the ECU 6 may control the vehicle 1 so that the vehicle 1 is autonomously driven based on images captured by the vehicle-mounted camera 2 and 3D information detected by the 3D sensor 3.

FIG. 2 is a view of the hardware configuration of the ECU 6. As shown in FIG. 2, the ECU 6 has a communication interface 21, memory 22, and processor 23. The communication interface 21 and memory 22 are connected through signal lines to the processor 23.

The communication interface 21 has an interface circuit for connecting the ECU 6 to the vehicle internal network 7. That is, the communication interface 21 is connected through the vehicle internal network 7 to the vehicle-mounted camera 2 and 3D sensor 3. Further, the communication interface 21 receives an image from the vehicle-mounted camera 2 and sends the received image to the processor 23. Similarly, the communication interface 21 receives 3D information from the 3D sensor 3 and sends the received 3D information to the processor 23.

The memory 22, for example, has a volatile semiconductor memory and nonvolatile semiconductor memory. The memory 22 stores various types of data used when the various types of processing are performed by the processor 23. For example, the memory 22 stores an image received from the vehicle-mounted camera 2, 3D information detected by the 3D sensor 3, map information, etc. Further, the memory 22 stores a computer program for performing the various types of processing by the processor 23.

The processor 23 has one or more CPUs (central processing units) and their peripheral circuits. The processor 23 may further have a GPU (graphics processing unit). The processor 23 performs the imaging abnormality diagnosis processing each time receiving 3D information from the 3D sensor 3 while the ignition switch of the vehicle 1 is on. Note that, the processor 23 may further have other processing circuits such as logic processing units or numeric processing units.

Further, the processor 23 may be configured to perform vehicle control processing controlling the vehicle 1 based on the image captured by the vehicle-mounted camera 2 and 3D information detected by the 3D sensor 3 so that the vehicle 1 is driven autonomously.

<<Imaging Abnormality Detection Processing>>

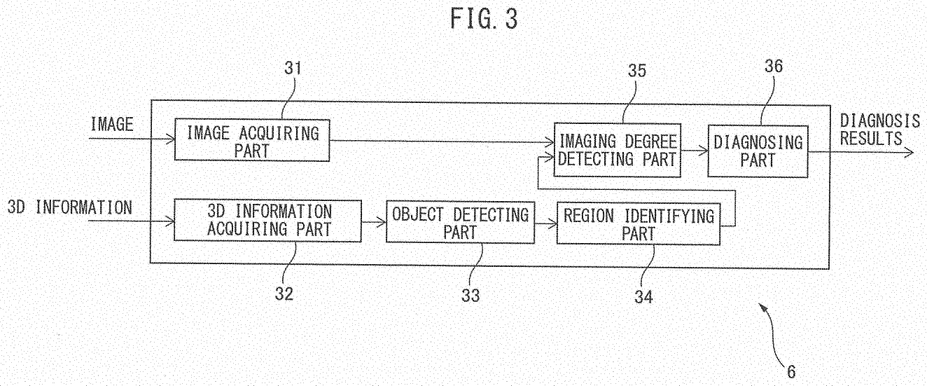

FIG. 3 is a functional block diagram of the ECU 6 relating to the imaging abnormality detection processing. The ECU 6 has an image acquiring part 31, 3D information acquiring part 32, object detecting part 33, region identifying part 34, imaging degree detecting part 35, and diagnosing part 36. These functional blocks of the ECU 6 are, for example, functional modules realized by a computer program operating on the processor 23. Note that, these functional blocks may also be dedicated processing circuits provided at the processor 23.

The image acquiring part 31 acquires an image of the vehicle surroundings captured by the vehicle-mounted camera 2 and sent to the communication interface 21. The image acquiring part 31 sends the acquired image to the imaging degree detecting part 35.

The 3D information acquiring part 32 acquires the 3D information of the vehicle surroundings detected by the 3D sensor 3 and sent to the communication interface 21. The 3D information acquiring part 32 sends the acquired 3D information to the object detecting part 33.

The object detecting part 33 detects the position and size of an object around the vehicle 1, based on the 3D information acquired by the 3D information acquiring part 32. If the 3D information is point cloud data including objects present in different directions around the vehicle 1, for example, the object detecting part 33 first processes this point cloud data by filtering to remove unnecessary information. In the filtering, for example, point clouds presumed to have been obtained by measuring the ground surface are detected and these point clouds are removed from the point cloud data. After that, the object detecting part 33 processes the remaining point cloud data by clustering whereby the position and size of an object around the vehicle 1 are detected. In clustering, for example, a point cloud present within a certain distance are treated as a cluster showing the same object. Therefore, each cluster is treated as showing the same single object. For example, in the object detecting part 33, the position of an object is detected based on the average distance or direction from the 3D sensor 3 in the point cloud data included in each cluster, while the size of the object is detected from the height “h” or the width “w” of each cluster. The object detecting part 33 sends data including the detected position and size of the object to the region identifying part 34.

Note that, the object detecting part 33 may use any method besides the above method to detect the position and size of an object around the vehicle 1, so long as able to detect them based on 3D information. For example, the object detecting part 33 may detect them by a neural network including convolutional layers (CNN). In this case, the values of the points in the point cloud data of the 3D information are input at the nodes of the input layer of the CNN. Further, the values of the weights used in the CNN are learned in advance using teacher data including correct data.

The region identifying part 34 identifies a region in which an object should appear in an image acquired by the image acquiring part 31 when the object appears in the image, based on the position and size of object detected by the object detecting part 33. Specifically, the region identifying part 34, for example, uses coordination transformation in the coordinate system at the 3D sensor 3 and the coordinate system at the vehicle-mounted camera 2 to identify a region in the image in which an object should appear.

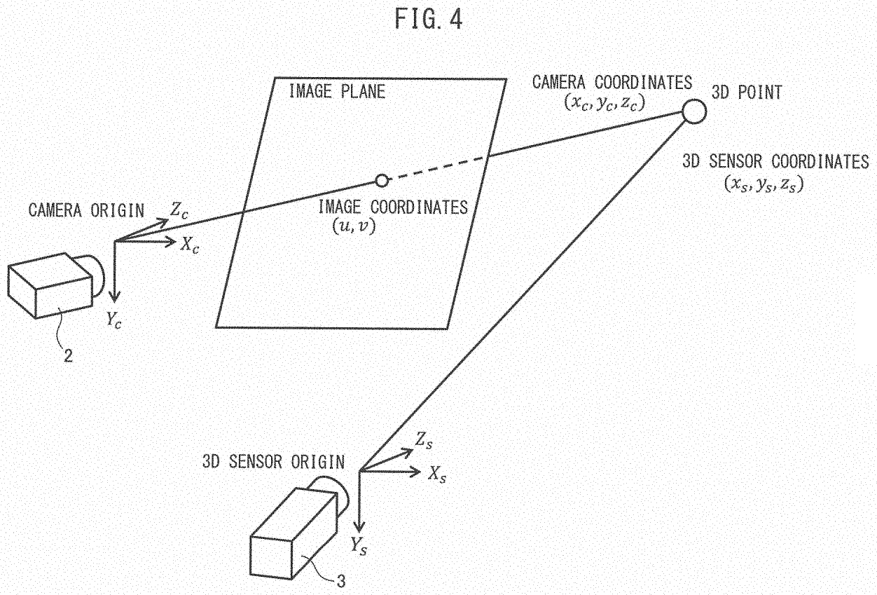

FIG. 4 is a view schematically showing a relationship of 3D coordinates of a 3D sensor 3 and a vehicle-mounted camera 2 and image coordinates. As will be understood from FIG. 4, the coordinate system having the 3D sensor 3 as its origin (Xₛ, Yₛ, Zₛ) and the coordinate system having the vehicle-mounted camera 2 as its origin (X_{c}, Y_{c}, Z_{c}) are separate coordinate systems. Further, the coordinates (xₛ, yₛ, zₛ) of a certain 3D point in the coordinate system having the 3D sensor 3 as its origin (Xₛ, Yₛ, Zₛ) can be converted to coordinates (x_{c}, y_{c}, z_{c}) in the coordinate system having the vehicle-mounted camera 2 as its origin. Further, if the coordinates (x_{c}, Y_{c}, z_{c}) of the above 3D point in the coordinate system having the vehicle-mounted camera 2 as its origin is known, it is possible to identify the coordinates (u, v) of the 3D point on the image when the 3D point is shown in the image.

Therefore, in the present embodiment, the region identifying part 34 converts the 3D coordinates of a set of 3D points clustered as indicating the same object (or part of the same) from the coordinate system having the 3D sensor 3 as its origin (Xₛ, Yₛ, Zₛ) to the coordinate system having the vehicle-mounted camera 2 as its origin (X_{c}, Y_{c}, Z_{c}). After that, the region identifying part 34 calculates a set of 2D coordinates (u, v) of an object when that object is shown in an image based on the set of 3D points indicating the same object converted to the coordinate system having the vehicle-mounted camera 2 as its origin (or part of the same). After that, the region identifying part 34 identifies regions in which the object should appear in an image when the object is shown in the image.

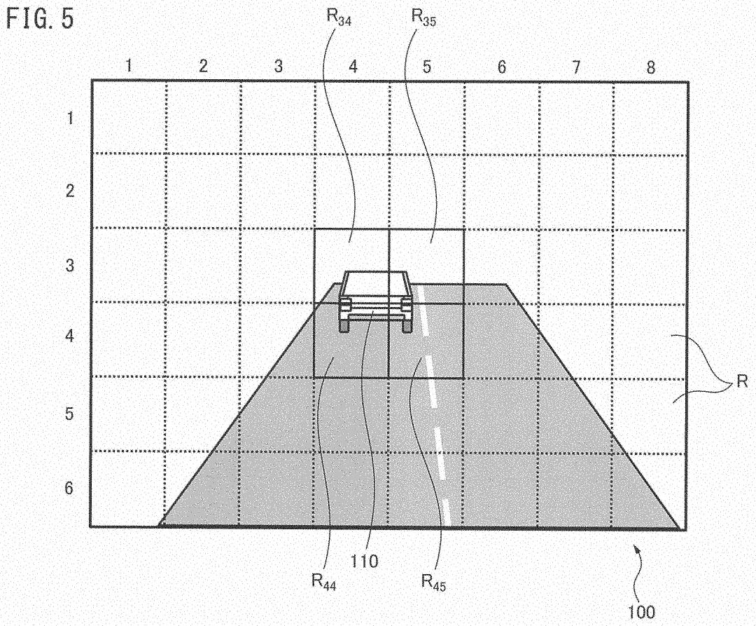

FIG. 5 shows one example of an image captured by the vehicle-mounted camera 2 and acquired by the image acquiring part 31. As shown in FIG. 5, the image 100 acquired by the image acquiring part 31 is divided into regions R of any image sizes. The image sizes of the regions are, for example, vertical×horizontal of 32 pixels×32 pixels. In the example shown in FIG. 5, the image 100 is divided into six in the vertical direction and is divided into eight in the horizontal direction. In the example shown in FIG. 5, a region of m-th from the top in the vertical direction and n-th from the left in the horizontal direction is shown as “Rₘₙ”.

In the image shown in FIG. 5, an object (vehicle) 110 is shown near the center. The region identifying part 34 identifies regions in which the object 110 should appear based on the 3D information detected by the 3D sensor 3. In the example shown in FIG. 5, the region identifying part 34 identifies the regions R₃₄, R₃₅, R₄₄, and R₄₅ as regions in which the object should appear.

Note that, in the image shown in FIG. 5, the road is also shown, but this is not recognized as an object. Therefore, the region identifying part 34 does not identify regions where only the road is shown (for example, R₅₂ to R₇₆) as regions in which an object should appear.

When a region in which an object should appear is identified by the region identifying part 34, that is, when it is judged that an object should appear in any region on an image by the region identifying part 34, the imaging degree detecting part 35 detects by analysis of that image an imaging degree as the degree by which the object is captured in this region. The imaging degree can be shown by various indicators.

As one indicator showing the imaging degree includes, for example, a texture degree. The texture degree indicates the degree by which an image is not flat, that is, the number of high frequency components or edge components contained in the image. Therefore, an image with a high flatness and small number of high frequency components or edge components has a low texture degree and accordingly can be said to be low in imaging degree. Conversely, an image with a low flatness and large number of high frequency components or edge components has a high texture degree and accordingly can be said to be high in imaging degree.

In this regard, for example, if an object is correctly shown in a region in which the object should appear in an image, the image of that region tends to be an image with a low flatness and accordingly to be an image with a high texture degree. On the other hand, if drops of water, snow, mud, dust, or other such foreign matter deposits on the lens of the vehicle-mounted camera 2 or the protective member (for example, front window) provided in front of the lens, that foreign matter will scatter or block the light whereby the image in the region where the foreign matter is deposited will be a blurred image or flat image.

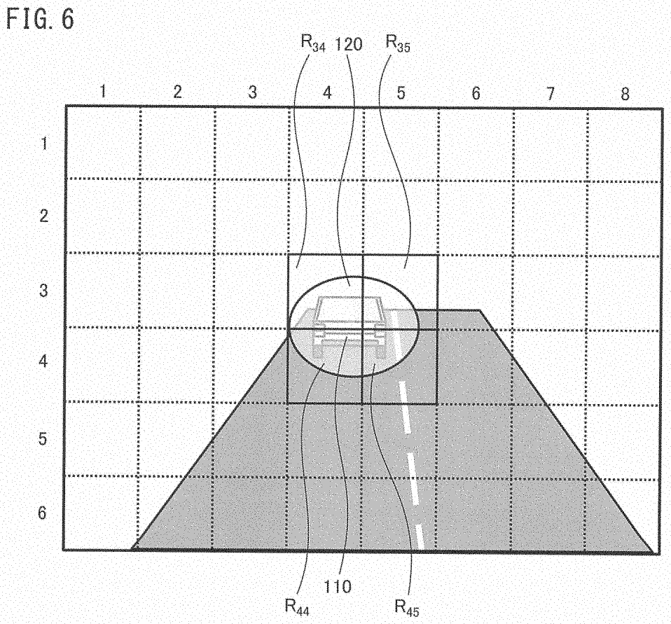

FIG. 6 shows one example of an image captured by a vehicle-mounted camera 2 and acquired by an image acquiring part 31. In particular, the image shown in FIG. 6 shows the case where foreign matter has deposited on the lens, etc., of the vehicle-mounted camera 2 and this foreign matter 120 causes the regions R₃₄, R₃₅, R₄₄, and R₄₅ to be blurred in image.

As will be understood from FIG. 6, the images of the regions where the foreign matter has deposited (R₃₄, R₃₅, R₄₄, and R₄₅) become images high in flatness and accordingly tend to become images with low texture degrees. In particular, the regions R₃₄, R₃₅, R₄₄, and R₄₅ are regions where the object 110 should appear, therefore if there is no foreign matter there, the texture degree should become higher. Therefore, by detecting the texture degree of a region in which it is judged that an object appears, it is possible to diagnose the presence of any foreign matter at that region.

The texture degree of an image is for example evaluated based on the number of high frequency components included in the image. In this case, the greater the number of high frequency components, the higher the texture degree is judged as. The frequencies at the regions R are analyzed by any known method. Specifically, for example, the intensities of the frequency components are calculated by a discrete Fourier transform (DFT) or a fast Fourier transform (FFT). The intensity of the high frequency component having equal to or greater than a certain specific threshold value is used as the texture degree.

Alternatively, the texture degree of the image may be evaluated based on the number of edge components included in the image. In this case, the greater the number of the edge components, the higher the texture degree is judged as. The edge components at the regions R are extracted by any known method. Specifically, for example, the edge components at the regions R are extracted by the Laplacian method, Sobel method, Canny method, etc. If using the Laplacian method as an example, the number of the points where the output values when filtering the images of the regions by a Laplacian filter (the output values become larger near the edges) are equal to or greater than a certain specific threshold value, is used as the texture degree.

Alternatively, the texture degree of an image may be evaluated based on the variance at the points of the image. In this case, the larger the variance, the higher the texture degree is judged as. Specifically, the variance at the points of the regions is found as variance of the brightnesses of the points or as variance of the intensity of one or more colors among RGB. In this case, the number of points where the value of the variance is equal to or greater than a certain specific threshold value may be used as the texture degree.

As another indicator indicating the imaging degree includes, for example, the confidence level by which an object appears in each region in an image (the probability of the object being present). The higher the confidence level by which an object appears in a certain region of the image, the more clearly that object appears in that region, therefore the higher the imaging degree of the region may be said to be.

The confidence level by which an object appears in each region is, for example, calculated using a neural network including convolutional layers. In this case, the CNN outputs the confidence level by which an object appears in each region of the image, if values of points of the image (brightness or RGB data) are input. Therefore, values of points of the image (brightness or RGB data) are input to the nodes of the input layer of the CNN. Further, the confidence level of each region of the image is output from a node of the output layer of the CNN. Further, the values of the weights used in the CNN are learned in advance using teacher data including correct data.

Note that, the confidence level by which an object appears in each region may be calculated by another method as well. For example, it is also possible to calculate the feature amount of HOG (histogram of oriented gradient) for each region of the image, and input the calculated feature amount into a classifier to calculate the confidence level.

The diagnosing part 36 judges that an abnormality is occurring in the imaging by the vehicle-mounted camera 2 if the imaging degree detected by the imaging degree detecting part 35 is equal to or less than a predetermined reference degree. Specifically, the diagnosing part 36 judges in such a case that foreign matter has deposited on the lens of the vehicle-mounted camera 2 or the protective member provided in front of the lens.

For example, if the texture degree is used as the imaging degree, if the texture degree of a region judged by the region identifying part 34 as a region where an object should appear is equal to or less than a predetermined threshold value, it is judged that an abnormality has occurred in the imaging by the vehicle-mounted camera 2. In this case, specifically, it is judged that an abnormality has occurred if the intensity of a specific frequency component equal to or higher than a threshold value among the frequency components contained in a certain region is equal to or less than a predetermined threshold value. Further, if confidence level is used as the imaging degree, if the confidence level of a region judged by the region identifying part 34 as a region where an object should appear is equal to or less than a predetermined threshold value, it is judged that an abnormality has occurred in the imaging by the vehicle-mounted camera 2.

The result of diagnosis by the diagnosing part 36 is utilized for other processing of the ECU 6 different from the imaging abnormality detection processing. For example, the result of diagnosis is utilized for interface control processing controlling the user interfaces (display or speakers) for transmitting information to the driver and passengers riding in the vehicle 1. In this case, when it is judged that an abnormality has occurred in the imaging by the vehicle-mounted camera 2, the ECU 6 warns the driver and passengers by the display or speakers.

Further, the result of diagnosis of the diagnosing part 36 is utilized for hardware control processing controlling the various types of hardware of the vehicle 1. In this case, when it is judged that an abnormality has occurred in the imaging by the vehicle-mounted camera 2, the ECU 6 actuates the first wiper 4 so as to wipe off foreign matter on the front window in front of the vehicle-mounted camera 2.

Alternatively, the results of diagnosis by the diagnosing part 36 are utilized for autonomous driving processing for controlling the vehicle 1 so that the vehicle 1 is autonomously driven. In this case, the ECU 6 suspends autonomous driving by autonomous driving processing when it is judged that an abnormality has occurred in the imaging by the vehicle-mounted camera 2.

<<Flow Chart>>

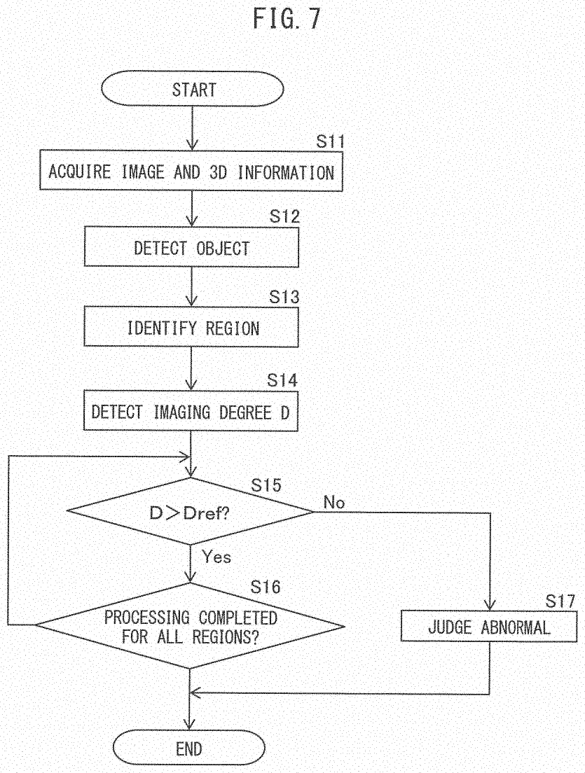

Next, referring to FIG. 7, imaging abnormality diagnosis processing will be explained. FIG. 7 is a flow chart showing imaging abnormality diagnosis processing. The imaging abnormality diagnosis processing shown in FIG. 7 is repeatedly performed at predetermined intervals by the processor 23 of the ECU 6. The predetermined intervals are, for example, the intervals at which 3D information is sent from the 3D sensor 3 to the ECU 6.

First, at step S11, the image acquiring part 31 acquires an image from the vehicle-mounted camera 2 through the communication interface 21. Similarly, the 3D information acquiring part 32 acquires 3D information from the 3D sensor 3 through the communication interface 21. The acquired image is input to the imaging degree detecting part 35, while the acquired 3D information is input to the object detecting part 33.

Next, at step S12, the object detecting part 33 detects the positions and sizes of objects around the vehicle 1 based on the 3D information. Specifically, the object detecting part 33 performs clustering on the point cloud data showing the 3D information whereby the positions and sizes of objects are detected based on the point cloud data belonging to the clusters showing the same objects.

Next, at step S13, the region identifying part 34 identifies regions in which an object should appear in the image acquired by the image acquiring part 31 if an object detected by the object detecting part 33 is shown in the image. Specifically, the region identifying part 34, for example, uses coordination transformation in the coordinate system at the 3D sensor 3 and the coordinate system at the vehicle-mounted camera 2 to identify regions in the image in which the object should appear.

Next, at step S14, the imaging degree detecting part 35 performs image processing, etc., to detect the imaging degree D as the degree by which the object is captured in the regions, in which the object should appear, identified by the region identifying part 34. Specifically, the imaging degree detecting part 35 calculates the texture degree of the regions in which the object should appear. Alternatively, the imaging degree detecting part 35 calculates the confidence level by which the object will be shown in a region in which the object should appear.

Next, at step S15, it is judged if the imaging degree D for a certain region detected at step S14 is greater than a predetermined reference degree Dref. The reference degree Dref may be a predetermined fixed value or may be a value changing in accordance with the type of or the distance to the object presumed to be shown in the region in which an object should appear, etc.

If at step S15 it is judged that the imaging degree D is greater than a reference degree Dref, that is, if the imaging degree D is high and it is believed that foreign matter, etc., is not present at that region, the routine proceeds to step S16. At step S16, it is judged if the processing of step S15 has been completed for all of the regions, where an object should appear, identified at step S13. If it is judged that the processing has still not been completed for some of the regions, the routine returns to step S15 where it is judged if the imaging degree D is equal to or greater than the reference degree Dref for another region where an object should appear. On the other hand, if at step S16 it is judged that the processing has been completed for all of the regions in which objects should appear, the control routine is ended without it being judged that an abnormality has occurred in the imaging by the vehicle-mounted camera 2.

On the other hand, if at step S15 it is judged that the imaging degree D is equal to or less than the reference degree Dref, that is, if the imaging degree D is low and it is believed that foreign matter, etc., is present at that region, the routine proceeds to step S17. At step S17, it is judged that an abnormality has occurred in the imaging by the vehicle-mounted camera 2 and the control routine is ended.

<<Action and Effects>>

According to the imaging abnormality diagnosis device of the present embodiment, a region in an image in which an object should appear is identified based on 3D information detected by the 3D sensor 3 and abnormality in that region is diagnosed based on the imaging degree in that region. For this reason, abnormality is not diagnosed for a region in which a large building is captured, that is, a region where the high frequency component is low in intensity. Due to this, abnormality of the lens, etc., of the vehicle-mounted camera 2 is kept from being erroneously judged in spite of foreign matter, etc., not being deposited.

Further, in the present embodiment, the vehicle-mounted camera 2 and 3D sensor 3 are attached to mutually different portions of the vehicle 1. Therefore, the vehicle-mounted camera 2 and 3D sensor 3 are arranged separated from each other, therefore these vehicle-mounted camera 2 and 3D sensor 3 are kept from becoming abnormal due to the same foreign matter.

<<Modifications>>

In the above embodiment, the imaging degree detecting part 35 detects the imaging degree for only a region identified by the region identifying part 34 as a region where an object should appear. However, in one modification, the imaging degree detecting part 35 may detect the imaging degrees for not only regions identified by the region identifying part 34 as regions where an object should appear, but for all of the regions on the image. In this case, the imaging degree detecting part 35 calculates, for example, the texture degree or the confidence level by which an object will appear for all of the regions on the image. In this case, it is possible to detect the imaging degrees of regions before the regions are identified by the region identifying part 34, therefore it is possible to detect the imaging degrees of regions relatively early.

### Second Embodiment

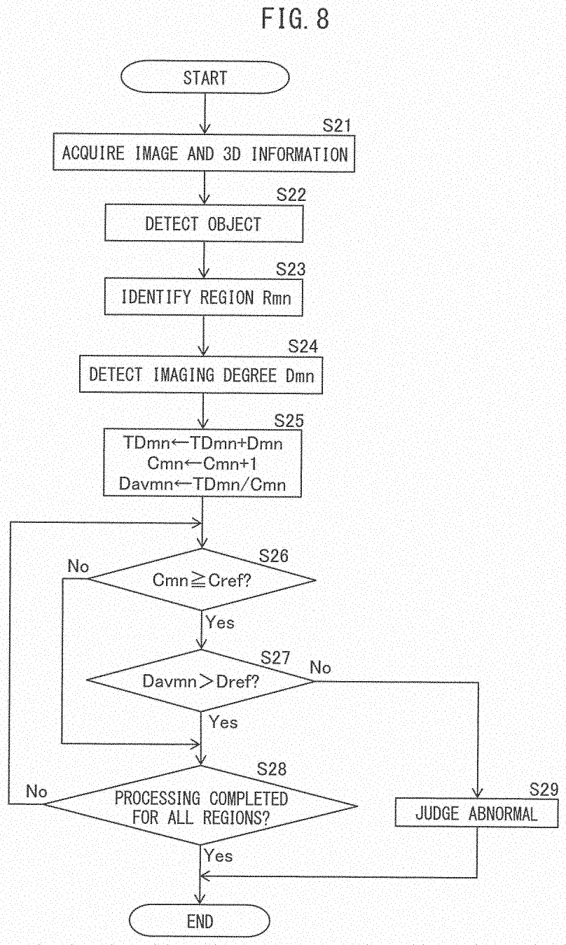

Next, referring to FIG. 8, an imaging abnormality diagnosis device according to a second embodiment will be explained. Below, the parts different from the imaging abnormality diagnosis device according to the first embodiment and the vehicle including the imaging abnormality diagnosis device will be focused on in the explanation.

In the above-mentioned first embodiment, the diagnosing part diagnoses an abnormality such as foreign matter in a region based on a single image of a time when an object should appear in some sort of region. However, if considering the possibility of noise, etc., arising in the imaging degree, there is a possibility of erroneous judgment if diagnosing an abnormality based on only one image.

Therefore, in the present embodiment, the diagnosing part 36 calculates a statistical value by time series processing of an imaging degree in a region detected by the imaging degree detecting part 35 for a plurality of images in which the region identified by the region identifying part 34 is the same as each other, and judges that an abnormality is occurring in imaging by the vehicle-mounted camera 2 when this statistical value is equal to or less than a predetermined value.

Specifically, in the same way as the first embodiment, the region identifying part 34 identifies regions in which an object should appear, based on the 3D information detected by the 3D sensor 3 at a certain point of time. Further, in the same way as the first embodiment, the imaging degree detecting part 35 detects the imaging degree Dmn in each region identified by the region identifying part 34.

In the present embodiment, the diagnosing part 36 calculates the average value Davmn of the imaging degree Dmn at a region detected a plurality of times by the imaging degree detecting part 35 after it is judged by the region identifying part 34 that an object is shown a plurality of times in a certain region in the images during any time period. Further, the diagnosing part 36 judges that an abnormality has occurred in the imaging by the vehicle-mounted camera 2 if the average value Davmn of this imaging degree is equal to or less than a predetermined reference degree Dref.

Note that, in the present embodiment, as the value used for the diagnosis of abnormality, the average value Davmn on the time series of the imaging degree for a certain region Rₘₙ is used. However, the value used for the diagnosis of abnormality can be found by various known filtering techniques along with the time series. Such a filtering technique includes, specifically, for example, an IIR (Infinite Impulse Response) filter. Therefore, in the present embodiment, the diagnosing part 36 can be said to judge that an abnormality is occurring in imaging by the vehicle-mounted camera when a statistical value obtained by time series processing of an imaging degree in a region detected by the imaging degree detecting part 35 for a plurality of images of which regions identified by the region identifying part 34 are the same, is equal to or less than a predetermined value.

FIG. 8 is a flow chart, similar to FIG. 7, showing imaging abnormality diagnosis processing according to the second embodiment. Steps S21, S22 shown in FIG. 8 are respectively similar to steps S11, S12 of FIG. 7, therefore explanations thereof will be omitted.

At step S23, the region identifying part 34 identifies a region Rmn in which an object should appear in an image. When there are a plurality of regions in which the object should appear, the region identifying part 34 identifies all of the regions Rmn.

At step S24, the imaging degree detecting part 35 performs image processing, etc., on each region Rnm identified by the region identifying part 34 so as to detect an imaging degree Dmn as a degree by which an object is captured. When there are a plurality of identified regions, it detects the imaging degrees Dmn for all of the regions Rmn.

Next, at step S25, for each region Rmn identified by the region identifying part 34, the value of the total sum TDmn of the imaging degrees of that region plus the imaging degree Dmn at that region Rmn calculated at step S24 is made the new total sum (TDmn=TDmn+Dmn). In addition, a counter Cmn showing the number of times by which the region Rmn is identified by the region identifying part 34 as a region in which the object appears, is incremented by 1 (Cmn=Cmn+1). Furthermore, by dividing the total sum TDmn of the imaging degree by the value of the counter Cmn for each region Rmn, the average value Davmn of the imaging degree in the region Rmn is calculated (Davmn TDmn/Cmn).

Next, at step S26, it is judged if the value of the counter Cmn is equal to or greater than a reference value Cref (for example, 10 times) for a certain region Rmn. If it is judged that the value of the counter Cmn is less than the reference value Cref, step S27 is skipped and the control routine proceeds to step S28. On the other hand, if at step S26 it is judged that the value of the counter Cmn is equal to or greater than the reference value Cref, the routine proceeds to step S27.

At step S27, it is judged if the average value Davmn of the imaging degree for a certain region Rmn is greater than a reference degree Dref. If at step S27 it is judged that the average value Davmn of the imaging degree is greater than the reference degree Dref, that is, if the imaging degree D is high and it is not believed that foreign matter, etc., is present in that region, the routine proceeds to step S28. At step S28, it is judged if the processing of steps S26, S27 has been completed for all of the regions identified at step S13. If it is judged that the processing has still not been completed for some of the regions, the routine returns to step S26. Then, steps S26, S27 are repeated until the processing has finished for all of the regions identified at step S23. On the other hand, if at step S28 it is judged that the processing has been completed for all of the regions, the control routine is ended without it being judged that an abnormality has arisen in the imaging by the vehicle-mounted camera 2.

On the other hand, if at step S27 it is judged that the average value Davmn of the imaging degree for a certain region Rmn is equal to or less than a reference degree Dref, that is, if the imaging degree D was low and it is believed the foreign matter, etc., are present in that region, the routine proceeds to step S29. At step S29, it is judged that an abnormality has arisen in the imaging by the vehicle-mounted camera 2 and the control routine is ended.

In the above, embodiments were explained, but the present disclosure is not limited to the above embodiments and can be corrected and modified in various ways.

### REFERENCE SIGNS LIST

1. vehicle
2. vehicle-mounted camera
3. 3D sensor
6. electronic control unit (ECU)
31. image acquiring part
32. 3D information acquiring part
33. object detecting part
34. region identifying part
35. imaging degree detecting part
36. diagnosing part

1. An imaging abnormality diagnosis device, configured to:
acquire an image of surroundings of a vehicle captured by a vehicle-mounted camera;
acquire 3D information of surroundings of the vehicle detected by a 3D sensor;
identify a region of the image in which an object should appear based on the acquired 3D information;
analyze the image to thereby detect an imaging degree as a degree by which an object is captured in a predetermined region of the image; and
judge that an abnormality has occurred in imaging by the vehicle-mounted camera when the imaging degree in the region, in which the object should appear, is equal to or less than a predetermined degree.

2. The imaging abnormality diagnosis device according to claim 1, wherein a texture degree of the image is used as the imaging degree, and the higher the texture degree of the image, the higher the imaging degree to the image is treated as.

3. The imaging abnormality diagnosis device according to claim 1, wherein a confidence level of an object being present in each region in an image is used as the imaging degree, and the higher the confidence level, the higher the imaging degree to the image is treated as.

4. The imaging abnormality diagnosis device according to claim 1, configured to detect the imaging degree in only a region in which the object should appear, when detecting the imaging degree.

5. The imaging abnormality diagnosis device according to claim 1, configured to judge that an abnormality has occurred in imaging by the vehicle-mounted camera, when a statistical value obtained by time series processing of an imaging degree in a region detected by an imaging degree detecting part for a plurality of images in which the region identified by a region identifying part is the same as each other, is equal to or less than a predetermined value, when judging that an abnormality has occurred in imaging.

6. A vehicle comprising the imaging abnormality diagnosis device according to claim 1, the vehicle comprising: the vehicle-mounted camera capturing the surroundings of the vehicle; and the 3D sensor detecting the 3D information of the surroundings of the vehicle, the vehicle-mounted camera and the 3D sensor being attached at different portions of the vehicle.
